(19) United States
(12) Patent Application Publication
(10) Pub. No.: US 2005/0088533 A1
(43) Pub. Date: Apr. 28, 2005

(54) System and method for remotely controlling cameras

(75) Inventors: Chi-Chih Wang, Tu-Cheng (TW); Bing-Yu He, Shenzhen (CN); Zhi-Meng Cao, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 10/929,007

(22) Filed: Aug. 27, 2004

(30) Foreign Application Priority Data
Oct. 22, 2003 (TW) 092129252

(51) Int. Cl. H04N 5/232

(52) U.S. Cl. 348/211.99

(57) ABSTRACT

A system for remotely controlling cameras includes an application server (3), a database (5), and a plurality of client computers (1). The application server includes: a connecting module (31) for connecting a corresponding camera to the application server; a camera controlling module (32) for controlling and adjusting the cameras to obtain clearer signals; a video signal collecting module (33) for collecting video signals; a video signal compiling module (34) for compiling the video signals into video data that can be viewed by users; and a data transmitting module (35) for transmitting the video data to the client computers. A related method for remotely controlling cameras is also disclosed.

### BACKGROUND OF THE INVENTION

1. Field of the invention

The present invention relates to a systems and methods for controlling cameras, and especially to systems and methods for remotely controlling cameras.

2. Related art

Nowadays in many factories, a remote controller is used to obtain video signals of objects being filmed on a factory floor. When a camera on the factory floor receives a remote control signal transmitted from a remote controller, a focusing operation is first carried out and thereafter a filming operation is carried out. The art of focusing a camera is disclosed in patents such as U.S. Pat. No. 5,119,123 entitled Camera Having A Remote Control Function. This invention limits the range of focal lengths that the camera can employ when used with a remote control, and also sets the camera aperture to maximize the depth of the field in the resulting images obtained, so as to increase the likelihood that the desired object is in focus.

However, if a user carries out the focusing operation to obtain a desired image of an object while observing the object through a view finder, and thereafter transmits the remote control signal, the desired object is liable to be out of focus and blurred once the filming operation begins. This is because the auto-focus device of the camera may focus on an object other than the desired object. As a result, the user may not be able to identify the desired object during filming, or the desired object may be too indistinct. In order to circumvent these problems, it is necessary for the user to manually switch the auto-focus mode to a manual mode. This mode switching operation is unduly troublesome.

In addition, the restricted range of focal lengths and preset camera aperture limit the user's choices for composing scenes and creating special video effects.

To overcome the above limitations, it is possible to transmit image data to a personal computer through a wired or a wireless transmission system, and to record the image data in the memory of the personal computer. However, this solution necessarily requires extra equipment in the form of a personal computer in order to record the image data.

### SUMMARY OF THE INVENTION

A main objective of the present invention is to provide a system and method for remotely controlling cameras, which is able to not only record image data, but also to control movement and adjustment of the cameras.

To accomplish the above objective, a system for remotely controlling cameras in accordance with a preferred embodiment of the present invention comprises an application server, a web server, a corporation website, a database, a plurality of remotely located video cameras, and a plurality of client computers. The application server comprises: a connecting module for connecting a corresponding camera to the application server according to a connecting request input by a user via a client computer; a camera controlling module for remotely controlling and adjusting the camera to obtain desired video signals; a video signal collecting module for collecting the video signals; a video signal compiling module for compiling the video signals into video data that can be viewed by the users; and a data transmitting module for transmitting the video data to the client computers.

The present invention also provides a method for remotely controlling cameras. The method comprises the steps of: (1) providing a graphical user interface, which comprises a plurality of camera control buttons; (2) connecting a corresponding remote video camera according to a camera select command input by a user; (3) performing one or more camera control operations to control and adjust the camera and obtain desired video signals; (4) collecting the video signals; (5) compiling the video signals into video data that can be viewed by the user; and (6) transmitting the video data to one or more client computers.

Other objects, advantages and novel features of the present invention will be drawn from the following detailed description of the preferred embodiment and preferred methods of the present invention with the attached drawings, in which:

### BRIEF DESCRIPTION OF THE DRAWINGS

FIG. 1 is a schematic diagram of hardware configuration of a system for remotely controlling cameras in accordance with the preferred embodiment of the present invention;

FIG. 2 is a schematic diagram showing main software function modules of a web server of the system of FIG. 1;

FIG. 3 is a schematic diagram showing main software function modules of an application server of the system of FIG. 1;

FIG. 4 is a schematic diagram showing main software function sub-modules of a camera controlling module of the application server of FIG. 3;

FIG. 5 is an exemplary graphical user interface for remotely controlling cameras according to the present invention;

FIG. 6 is a flowchart of a preferred method for remotely controlling cameras according to the present invention; and

FIG. 7 is a flowchart of a process for controlling a camera according to commands input by a user according to the present invention.

### DETAILED DESCRIPTION OF THE INVENTION

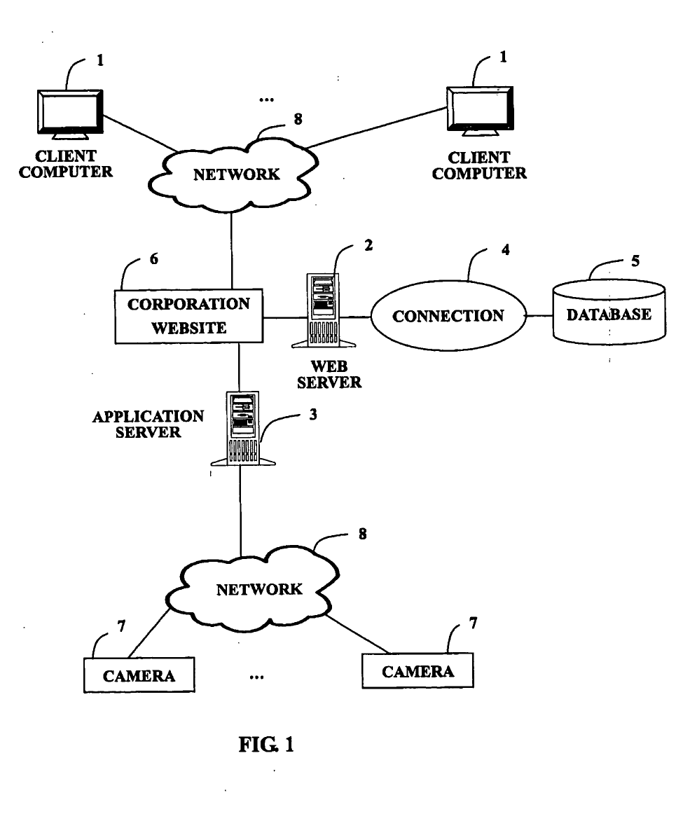

FIG. 1 is a schematic diagram of hardware configuration of a system for remotely controlling cameras (hereinafter, “the system”) in accordance with the preferred embodiment of the present invention. The system comprises a plurality of client computers 1, a web server 2, an application server 3, a connection 4, a database 5, a corporation website 6, a plurality of remotely located video cameras 7, and a network 8. Each client computer 1 is for users to log on the corporation website 6 in order to input commands, and for displaying results of implementation of such commands. The corporation website 6 provides an interactive user interface for users to perform camera control operations. The camera control operations include:

angle control, automatic rotation control, manual focusing control, and auto-focus control. The web server 2 comprises a plurality of software function modules for identifying users and their camera access authorities. The application server 3 also comprises a plurality of software function modules for collecting video signals according to users' connecting requests, compiling the video signals into video data that can be viewed by the users, and transmitting the video data to the client computers 1. The database 5 stores basic user information, users' access authorities, and the video data. The cameras 7 capture the video signals according to commands input by the users.

The client computers 1 are connected to the corporation website 6 via the network 8. The network 8 may be an intranet, the Internet, or any other suitable type of communications link. The web server 2 is connected to the database 5 via the connection 4, which is one kind of database connectivity such as an Open Database Connectivity (ODBC) or a Java Database Connectivity (JDBC). The cameras 7 are connected to the application server 3 via the network 8.

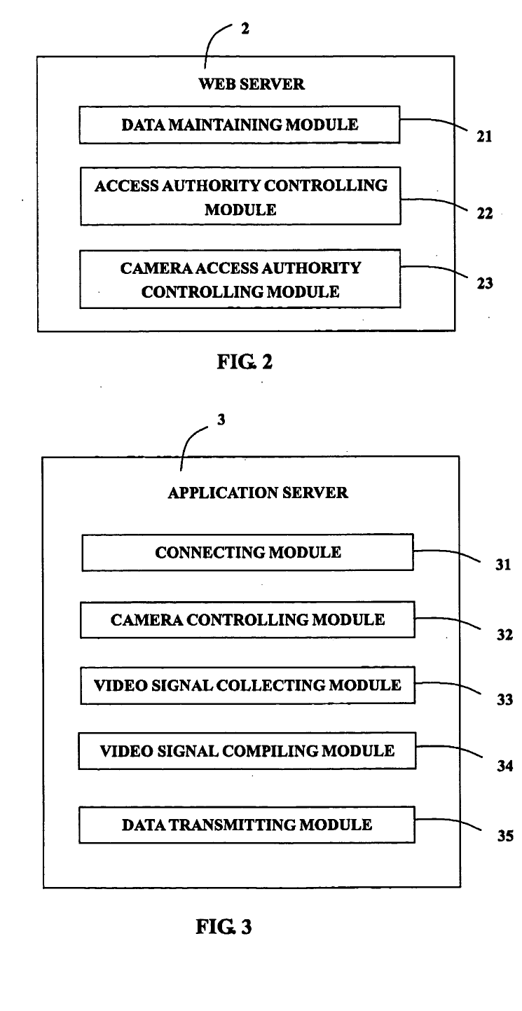

FIG. 2 is a schematic diagram showing main software function modules of the web server 2. The web server 2 comprises a data maintaining module 21, a system access authority controlling module 22, and a camera access authority controlling module 23.

The data maintaining module 21 is used for maintaining user information. The user information includes basic user information, and camera access authorities of the users. Maintaining operations include reading, writing, deleting, modifying, and backing up the user information. The system access authority controlling module 22 receives an ID and a password input by each user via the corporation website 6, and identifies whether the ID and password are valid according to the user information stored in the database 5. If an ID and/or a corresponding password is/are invalid, the system access authority controlling module 22 refuses access by the user to the system. The camera access authority controlling module 23 lists all cameras 7 that can be accessed by each user, and controls accessing by all the users.

FIG. 3 is a schematic diagram showing main software function modules of the application server 3. The application server 3 comprises a connecting module 31, a camera controlling module 32, a video signal collecting module 33, a video signal compiling module 34, and a data transmitting module 35.

The connecting module 31 is used for connecting a corresponding camera 7 to the application server 3 according to a connecting request input by a user via a client computer 1. The camera controlling module 32 is used for remotely controlling the camera 7. The video signal collecting module 33 is used for collecting video signals from the camera 7. The video signal compiling module 34 is used for compiling the video signals into human-viewable video data. The data transmitting module 35 is used for transmitting the video data to the client computers 1.

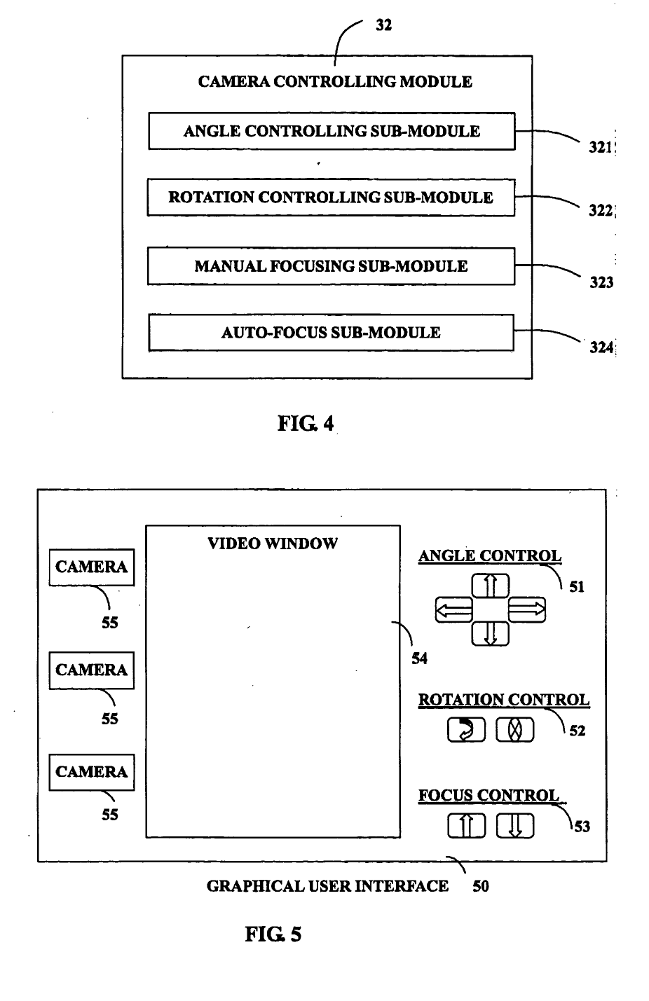

FIG. 4 is a schematic diagram showing main software function sub-modules of the camera controlling module 32. The camera controlling module 32 comprises an angle controlling sub-module 321, a rotation controlling sub-module 322, a manual focusing sub-module 323, and an auto-focus sub-module 324.

The angle controlling sub-module 321 is used for adjusting camera angles. The adjustments specifically include controlling a lens of a camera 7 to move upward or downward, controlling the lens to turn right or left, etc. The rotation controlling sub-module 322 is used for automatically rotating the camera 7 to obtain clearer signals. The manual focusing sub-module 323 is used for manually focusing the camera 7 to enhance the image clarity. The adjustments specifically include adjusting the lens to focus more on images of distant objects, and adjusting the lens to focus more on images of near objects. The auto-focus sub-module 324 is used for auto-focusing the camera 7.

FIG. 5 is an exemplary graphical user interface 50 for remotely controlling cameras according to the present invention. The graphical user interface 50 used to receive any valid control data input comprises a plurality of camera control buttons: angle control 51, rotation control 52, focus control 53, video window 54, and a plurality of cameras 55. Through the video window 54, a user can view scenes controlled by a selected camera 7 in real time, and play video data stored in the database 5. When the user clicks on one of the camera 55 buttons using a computer mouse, the connecting module 31 automatically connects a corresponding camera 7. The angle control 51 is for the user to select a camera angle. The rotation control 52 is used for automatically rotating the camera 7 in order to obtain clearer signals. The focus control 53 is used for focusing the camera 7. When the user operates the camera control buttons, the application server 3 runs corresponding modules to control the camera 7.

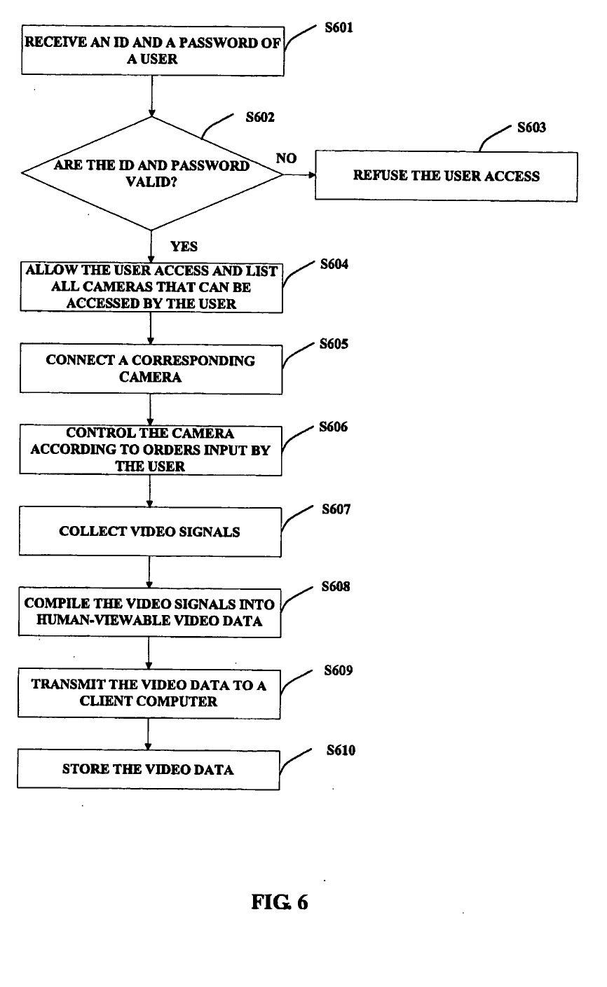

FIG. 6 is a flowchart of a preferred method for remotely controlling cameras according to the present invention. In step S601, the system access authority controlling module 22 receives an ID and a password input by a user via the corporation website 6. In step S602, the system access authority controlling module 22 identifies whether the ID and password are valid according to user information stored in the database 5. If the ID and/or password are/is invalid, in step S603, the system access authority controlling module 22 refuses access by the user to the system. If the ID and password are valid, in step S604, the camera access authority controlling module 23 lists all cameras 7 that can be accessed by the user. In step S605, the connecting module 31 connects a corresponding camera 7 according to a connecting request input by the user via the client computer 1. In step S606, the camera controlling module 32 controls and adjusts the camera 7 to obtain focused images, according to commands input by the user. In step S607, the video signal collecting module 33 collects video signals from the camera 7. In step S608, the video signal compiling module 34 compiles the video signals into human-viewable video data. In step S609, the data transmitting module 35 transmits the video data to a predetermined saving space of the client computer 1. In step S610, the data transmitting module 35 stores the video data in the database 5.

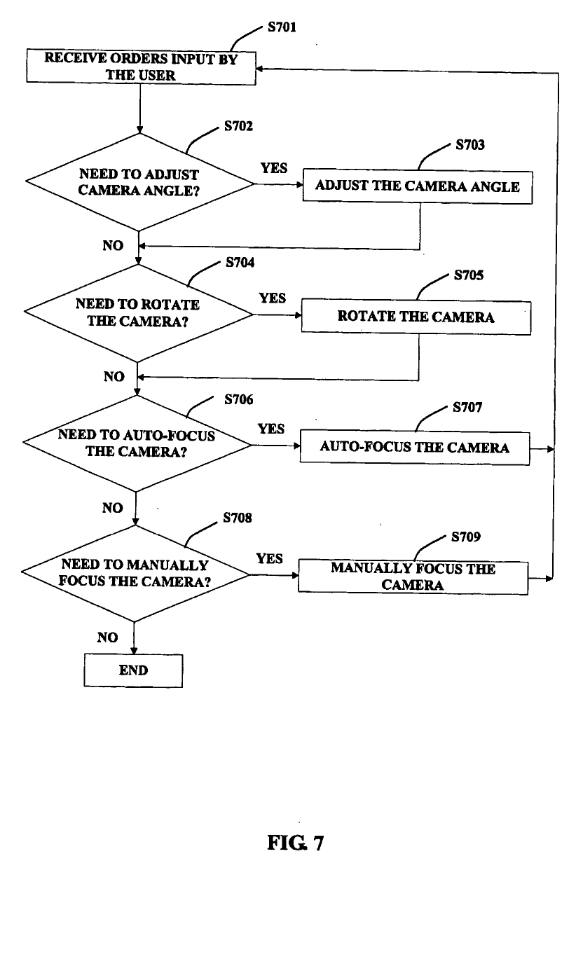

FIG. 7 is a flowchart of details of step S606 of FIG. 6, namely controlling and adjusting a camera 7 according to commands input by the user. In step S701, the application server 3 receives the commands input by the user via the client computer 1. In step S702, the angle controlling sub-module 321 determines whether there is a need to adjust the camera angle according to the commands. If there is a need to adjust the camera angle, in step S703, the angle controlling sub-module 331 adjusts the camera angle accordingly. Adjustments specifically can include controlling the lens to move upward or downward, and controlling the lens to turn right or left. If there is no need to adjust the camera angle, or after adjustment of the camera angle, in step S704, the rotation controlling sub-module 322 determines whether there is a need to automatically rotate the camera 7. If there is a need to automatically rotate the camera 7, in step S705, the rotation controlling sub-module 322 causes the camera 7 to rotate automatically. If there is no need to automatically rotate the camera 7, or after the camera 7 is caused to rotate automatically, in step S706, the auto-focus sub-module 324 determines whether there is a need to auto-focus the camera 7. If there is a need to auto-focus the camera 7, in step S707, the auto-focus sub-module 324 auto-focuses the camera 7, whereupon the procedure returns to step S701 described above. If there is no need to auto-focus the camera 7, in step S708, the manual focusing module 323 determines whether there is a need to manually focus the camera 7. If there is a need to manually focus the camera 7, in step S709, the manual focusing module 323 facilitates the necessary adjustments. The adjustments can include adjusting the lens to focus more on images of distant objects, and adjusting the lens to focus more on images of near objects. After the adjustments are made, the procedure returns to step S701 described above. If there is no need to manually focus the camera 7, the procedure is ended.

Although the present invention has been specifically described on the basis of a preferred embodiment and preferred methods, the invention is not to be construed as being limited thereto. Various changes or modifications may be made to said embodiment and methods without departing from the scope and spirit of the invention.

1. A system for remotely controlling cameras, the system comprising a plurality of client computers, a web server, an application server, a database, a corporation website, and a plurality of cameras, wherein the application server comprises:
a camera controlling module for controlling and adjusting the cameras to obtain adjusted video signals, the camera controlling module comprising:
an angle controlling sub-module for adjusting angles of the cameras;
a rotation controlling sub-module for automatically rotating the cameras;
a manual focusing module for manually focusing the cameras to enhance image clarity; and
an auto-focus sub-module for auto-focusing the cameras.

2. The system according to claim 1, wherein the application server further comprises a connecting module for connecting a corresponding camera to the application server according to a connecting request input by a user via a client computer.

3. The system according to claim 1, wherein the application server further comprises a video signal collecting module for collecting video signals from the cameras.

4. The system according to claim 3, wherein the application server further comprises a video signal compiling module for compiling the video signals into human-viewable video data.

5. The system according to claim 4, wherein the application server further comprises a data transmitting module for transmitting the video data to the client computers.

6. A method for remotely controlling cameras, the method comprising the steps of:
providing a graphical user interface, which comprises a plurality of camera control buttons;
connecting a corresponding camera according to a connecting request input by a user via one of the camera control buttons;
controlling and adjusting the camera to obtain clearer video signals;
collecting the video signals from the camera;
compiling the video signals into video data that can be viewed by users; and
transmitting the video data to one or more client computers.

7. The method according to claim 6, wherein the step of controlling and adjusting the camera comprises any one or more of the following control operations: camera angle control, automatic rotation control, manual focus control, and auto-focus control.

8. A method for remotely controlling cameras, the method comprising the steps of:
providing a user interface to allow control data input;
starting control of a corresponding camera and promoting said camera to a ready status;
controlling said camera to be real-timely adjustable according to said control data input;
controlling said camera to be adjustable from a preset auto-focusing filming status to a manual-focusing filming status;
starting filming to get video signals according to said control data input, and compiling said video signals into human-viewable video data; and
transmitting said video data to a predetermined saving space.

9. The method according to claim 8, wherein said step of controlling said camera comprises one adjustment of the adjustment group consisting of camera angle control and automatic rotation control.
